(19) United States
(12) Patent Application Publication
(10) Pub. No.: US 2009/0033645 A1
(43) Pub. Date: Feb. 5, 2009

(54) Display device and operating method of the same

(75) Inventor: Azuma Araya, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/219,891

(22) Filed: Jul. 30, 2008

(30) Foreign Application Priority Data
Aug. 2, 2007 (JP) 2007-202353

(51) Int. Cl. G09G 5/00; G09G 3/36

(52) U.S. Cl. 345/205; 345/87

(57) ABSTRACT

A display device includes: a display control circuit and a memory. The display control circuit drives a display panel. The memory stores setting data for the display panel. The display control circuit reads the setting data from the memory in response to a blanking start signal indicative of a start timing of a blanking interval.

### INCORPORATION BY REFERENCE

This application is based upon and claims the benefit of priority from Japanese patent application No. 2007-202353 filed on Aug. 2, 2007, the disclosure of which is incorporated herein in its entirety by reference.

### BACKGROUND OF THE INVENTION

1. Field of the Invention

The present invention relates to a display device and an operating method of the same. More particularly, the present invention relates to a liquid crystal display device and an operating method of the same.

2. Description of Related Art

A liquid crystal display device is mounted on most of the portable electronic devices currently distributed on the market such as portable telephones or PDAs. A liquid crystal display device capable of displaying television images thereon is mounted on several recent models of a portable telephone. A display panel of a liquid crystal display device may undergo its peculiar variations in a threshold voltage or the like. In addition, an IC and discrete parts constituting a module including a display panel may undergo its variations in their performances.

There is known a technique of storing, in a memory, a value (hereinafter referred to as a setting value) obtained by executing an adjustment such as trimming of a reference value of a drive voltage, at an individual display panel (see, for example, Japanese Laid-Open Patent Application JP-P2003-241730A).

FIG. 1 is a block diagram showing a configuration of a liquid crystal display device disclosed in Japanese Laid-Open Patent Application JP-P2003-241730A. This related liquid crystal display device includes an external I/F circuit 101, a drive voltage generating circuit 102, a liquid crystal driving circuit 103, a display memory 104, a driver controller 105, an address control circuit 106, a setting register 107 and a non-volatile memory 108. In the related liquid crystal display device, a driving device for a display panel includes the liquid crystal driving circuit 103 and the drive voltage generating circuit 102. The non-volatile memory 108 stores required initial setting data therein. An address value is supplied through the external I/F circuit 101 to the address control circuit 106. A heading address in the non-volatile memory 108 is designated as an address pointer based on this address value, and then, the initial setting data are read in sequence. The read initial setting data are stored in the setting register 107, and then, initialization is executed by using the read initial setting data.

Year by year, resolution of a liquid crystal panel is increased as performance and functions are enhanced in the liquid crystal display device. With the increase of the resolution, a size of a display memory and a size of a display data processing circuit must be inevitably increased in the liquid crystal display device. In general, most of the portable electronic devices are driven by batteries. Therefore, it is desired that the liquid crystal display device mounted on the portable electronic device consumes small electric power. Here, there is known a technique of changing a setting value not only at an initial setting but also during image display in order to suppress any increase in current consumption. For example, there is a liquid crystal display device provided with a partial display mode (hereinafter referred to as a partial mode) in which images are displayed in a specified partial region while images are not displayed in other regions as a method for saving electric power consumption on a standby screen.

FIG. 2 is a block diagram showing a configuration of a display screen in a partial mode. FIG. 2 shows a screen transited from a normal display mode, in which images are normally displayed, to the partial mode. In FIG. 2, images are not displayed in a region from G001 to G181 or a region from G204 to G320 on a standby screen. In contrast, images are partially displayed in a region from G181 to G204 on the standby screen.

We have now discovered the following facts. In the liquid crystal display device disclosed in JP-P2003-241730A, the initial setting data stored in the non-volatile memory 108 are read at the timing when the address value of the address control circuit 106 is changed. Thereafter, the setting data stored in the setting register 107 are updated based on the read setting data. Consequently, in the case where the technique disclosed in JP-P2003-241730A is applied to the liquid crystal display device provided with the plurality of display modes, since the setting data of the setting register 107 are updated during image display in response to the change in the address value of the address control circuit 106, there is a possibility to influence image display.

Incidentally, a change mode herein indicates that the setting data is stored in the non-volatile memory, and then, the setting data in the non-volatile memory are read when necessary, besides a change from the normal display to the partial display or 8-color display, and a change in a gamma correction value.

Moreover, in the liquid crystal display device disclosed in JP-P2003-241730A, the address is set by a host (a device supplying display data to be displayed in the liquid crystal display device and not shown in FIG. 1) every mode change. In a case where the mode change is caused by an external factor, there arises a problem that the timing, at which the mode is changed, cannot be recognized by the host. For example, in a liquid crystal display device provided with an external light sensor and a gamma correction circuit for automatically changing a gamma correction value, for automatically changing the gamma correction value according to the brightness of light radiated to the display panel, the mode change depends upon an output of the external light sensor. Therefore, it may be often impossible to properly recognize the timing, at which the host changes the mode.

Additionally, if all of the setting data of respective modes are stored in registers in the liquid crystal display device, the circuit area is undesirably increased due to the increased number of registers.

### SUMMARY

The present invention seeks to solve one or more of the above problems, or to improve upon those problems at least in part. In one embodiment, a display device includes: a display control circuit configured to drive a display panel; and a memory configured to store setting data for the display panel, wherein the display control circuit reads the setting data from the memory in response to a blanking start signal indicative of a start timing of a blanking interval.

In another embodiment, a display driver circuit driving a display panel based on setting data, includes: a memory control circuit configured to read setting data from a memory; a setting register configured to store said read setting data; and a timing controller, wherein said timing controller outputs a blanking start signal indicative of a start timing of a blanking interval to said memory control circuit, and wherein said memory control circuit reads said setting data from said memory in response to said blanking start signal and outputs said setting data to said setting register.

In another embodiment, a display driver circuit includes: a control circuit configured to read setting data of a display panel from a memory in synchronization with a front porch which indicates a start timing of a blanking interval, and drive said display panel based on said setting data.

In another embodiment, an operation method of a display device, includes: outputting a blanking start signal indicative of a start timing of a blanking interval; reading setting data for a display panel from a memory in synchronization with said blanking start signal; and storing said setting data in a setting register.

In the present invention, when the mode is changed, the setting data stored in the memory are read at the start timing of the blanking interval after waiting the start of the blanking interval. This configuration is automatically set in the display device instead of the control from the host.

Therefore, the present invention provides a display device capable of changing or switching the modes without any adverse influence on image display even if an instruction of updating a setting data in a setting register is outputted during image display.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram illustrating a configuration of a liquid crystal display device in a related art;

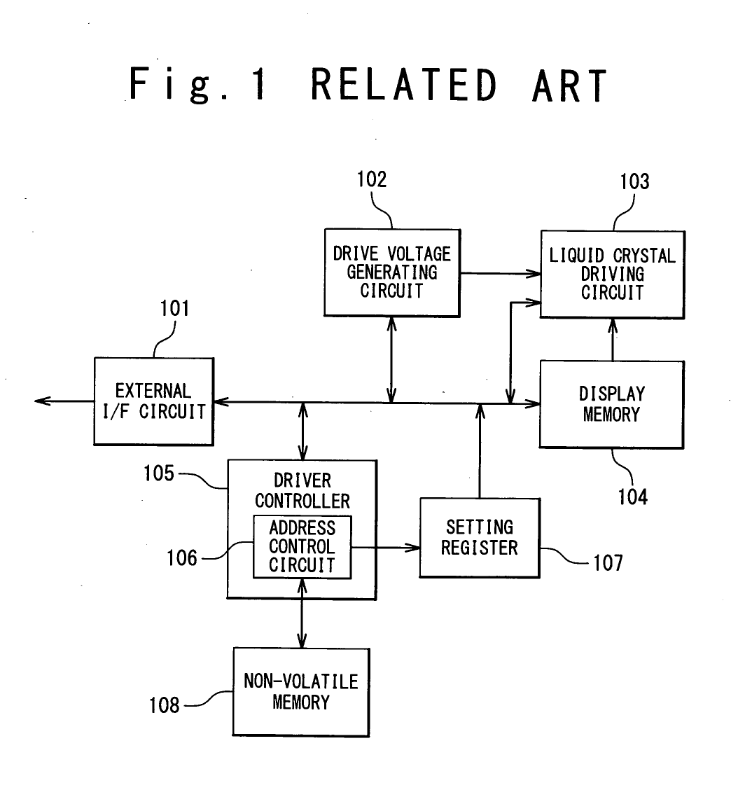

FIG. 2 is a block diagram illustrating a configuration of a display screen in a partial mode in a related art;

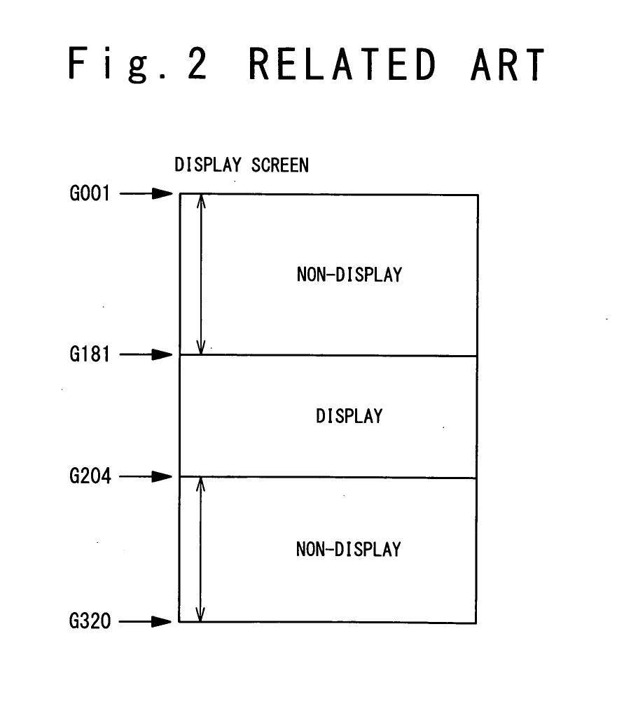

FIG. 3 is a block diagram illustrating a configuration of a portable electronic device according to an embodiment of the present invention;

FIG. 4 is a block diagram illustrating a detailed configuration of a display control circuit according to the embodiment of the present invention;

FIG. 5 is a block diagram illustrating a configuration of a non-volatile memory 7 according to the embodiment of the present invention; and

FIG. 6 is a timing chart illustrating an operation of the liquid crystal display device according to the embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

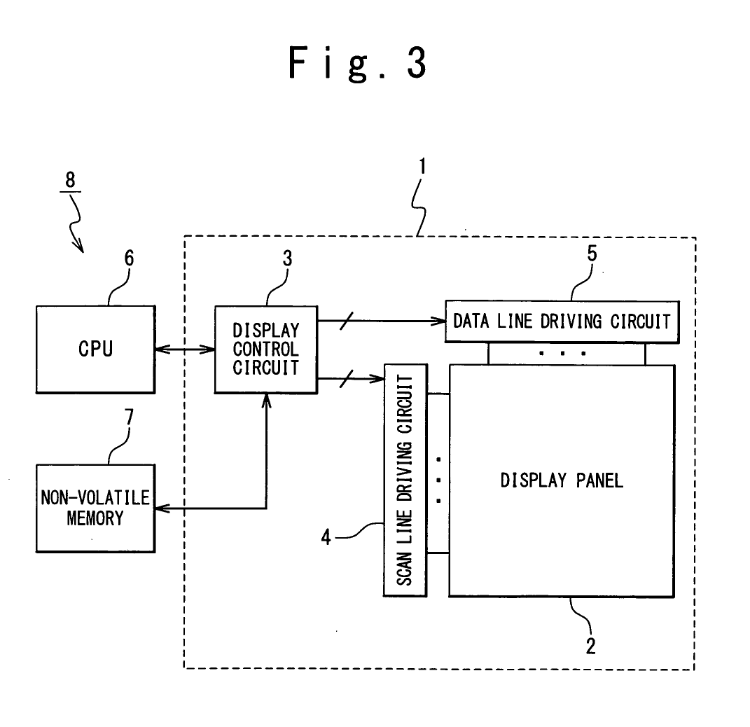

A display device according to an embodiment of the present invention will be described with reference to the attached drawings. FIG. 3 is a block diagram showing a configuration of a portable electronic device 8 including a liquid crystal display device 1 in the present embodiment. In the following embodiment, the portable electronic device 8 exemplifies a cell phone in order to easily understand the present invention.

The portable electronic device 8 includes the liquid crystal display device 1, a CPU 6 and a non-volatile memory 7. The liquid crystal display device 1 includes a display panel 2, a display control circuit 3, a scan line driving circuit 4 and a data line driving circuit 5. The CPU 6 is installed in a device for supplying display data to be displayed in the liquid crystal display device 1 (hereinafter referred to as a “host”). The non-volatile memory 7 is provided outside of the liquid crystal display device 1, and stores therein setting values (setting data), such as reference values of drive voltages, corresponding to a plurality of display modes in the liquid crystal display device 1.

The display panel 2 of the liquid crystal display device 1 includes a plurality of pixels (not shown). The display panel 2 provides a user with images corresponding to the display data supplied from the host. The display control circuit 3 supplies the display data supplied from the CPU 6 to the scan line driving circuit 4 and the data line driving circuit 5. The scan line driving circuit 4 drives a plurality of scan lines provided in the display panel 2. The data line driving circuit 5 drives a plurality of data lines provided in the display panel 2. The display control circuit 3 is considered as a part of a display driver circuit which drives the display panel 2 based on setting data.

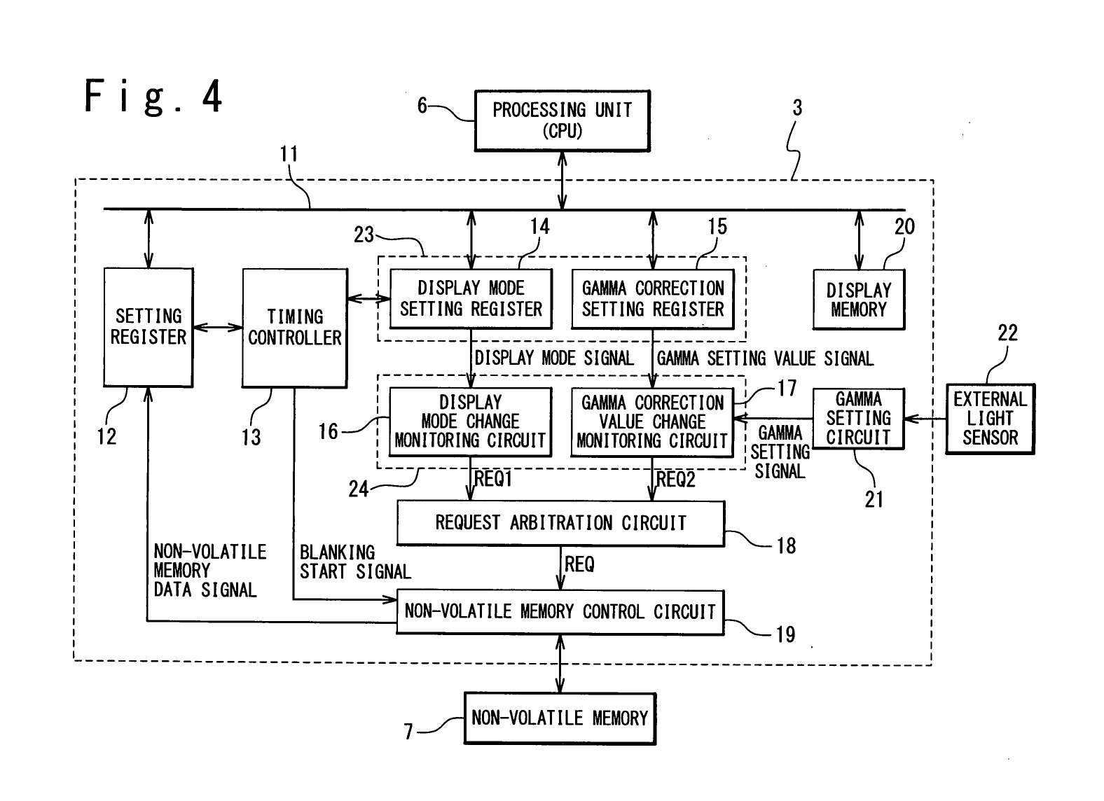

FIG. 4 is a block diagram showing a detailed configuration of the display control circuit 3. The display control circuit 3 includes a setting register 12, a timing controller 13, a display state register section 23, a display memory 20, a display state monitor section 24, a gamma setting circuit 21, a request arbiter circuit 18 and a non-volatile memory control circuit 19. The display control circuit 3 is connected to the CPU 6 via an interface 11. The setting register 12 stores therein setting value of the display control circuit 3, which are required for displaying images on the display panel 2. The timing controller 13 produces timings for displaying images.

The display state register section 23 includes a display mode setting register 14 and a gamma correction setting register 15. Furthermore, the display state monitor section 24 includes a display-mode-change monitoring circuit 16 and a gamma-correction-value-change monitoring circuit 17. The display mode setting register 14 stores therein the setting value of the display mode. The display-mode-change monitoring circuit 16 monitors a change in display mode. Furthermore, the gamma correction setting register 15 stores therein the setting value of the gamma correction. The gamma correction value change monitoring circuit 17 monitors a change in gamma correction.

The request arbiter circuit 18 arranges a priority order in a case where a plurality of requests are given at the same time. The non-volatile memory control circuit 19 controls a non-volatile memory. The display memory 20 stores therein data to be displayed on the screen. The gamma setting circuit 21 receives data supplied from an external light sensor 22 disposed outside of the liquid crystal display device, and then, calculates a gamma correction value. Here, the display mode setting register 14 and the gamma correction setting register 15 may be included in the setting register 12.

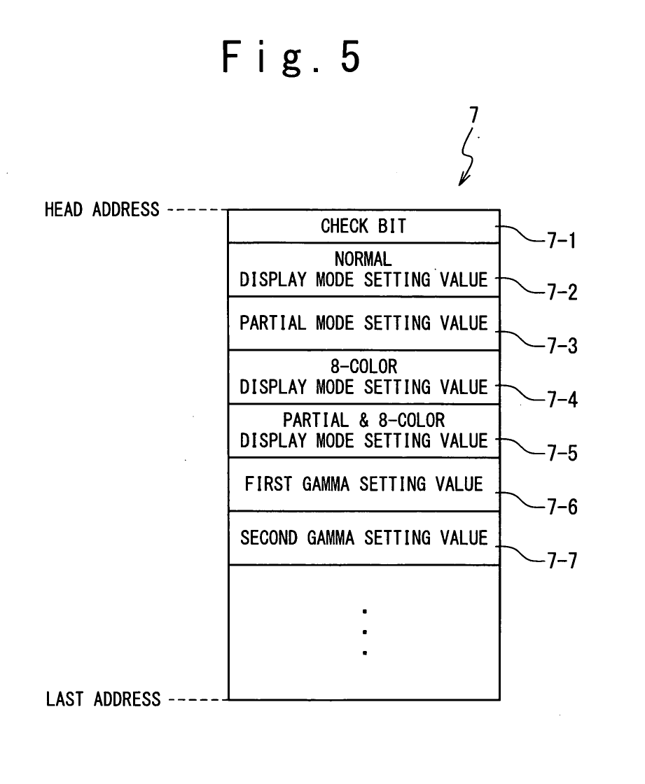

FIG. 5 is a block diagram showing a configuration of the non-volatile memory 7. The non-volatile memory 7 includes a plurality of regions. That is, the plurality of regions includes a check-bit storing region 7-1, a normal-display-mode-setting-value storing region 7-2, a partial-mode-setting-value storing region 7-3, an 8-color-display-mode-setting-value storing region 7-4, a partial & 8-color-display-mode-setting-value storing region 7-5, a first-gamma-setting-value storing region 7-6, and a second-gamma-setting-value storing region 7-7. The check-bit storing region 7-1 stores a check bit. The normal-display-mode-setting-value storing region 7-2 stores a normal display mode setting value. The partial-mode-setting-value storing region 7-3 stores a partial mode setting value. The 8-color-display-mode-setting-value storing region 7-4 stores an 8-color display mode setting value. The partial & 8-color-display-mode-setting-value storing region 7-5 stores a partial & 8-color display mode setting value. The first-gamma-setting-value storing region 7-6 stores a first gamma setting value. The second-gamma-setting-value storing region 7-7 stores a second gamma setting value.

The non-volatile memory 7 in the present embodiment includes the check bit region 7-1 at the head thereof, at which a check bit is held. In reading data stored in the non-volatile memory 7, the check bit is first read at all times. In a case where the check bit matches with an expected value previously stored in the liquid crystal display device 1, the setting values of each mode are continued to be read. In contrast, in a case where the check bit does not match with the expected value, it is determined that there occurs an abnormality in the non-volatile memory. In this case, further reading operation of the non-volatile memory 7 is stopped. In this manner, even in the case where the non-volatile memory 7 malfunctions or an abnormality occurs in wiring, it is possible to prevent the setting register from storing the abnormal data. Thus, it is possible to avoid displayed images in the display panel from being adversely affected by the abnormal data. Incidentally, the configuration and operation of the display device according to the present invention are not limited to the above-described configuration.

An operating method of the display device according to an embodiment of the present invention will be described with reference to the attached drawings. In a following embodiment, for the sake of easy understanding of the present invention, an explanation will be made on a case where the display mode is transited from the normal mode to the partial mode.

With reference to FIG. 4, after a reset release, the setting register 12, the display mode setting register 14 and the gamma correction setting register 15 are in an initial state in the liquid crystal display device 1. Then, the setting values are read from the non-volatile memory 7 and stored as initial setting values in the setting register 12 after the reset release. Thus, the display mode is decided due to the initial setting values in the setting register 12. Incidentally, the values read just after the reset release for the display mode is generally the normal display mode setting value stored in the normal-display-mode-setting-value storing region 7-2.

When the value stored in the display mode setting register 14 is changed, the display control circuit 3 starts an operation for changing the display mode. Here, the timing when the value stored in the display mode setting register 14 is changed is not limited in the present embodiment.

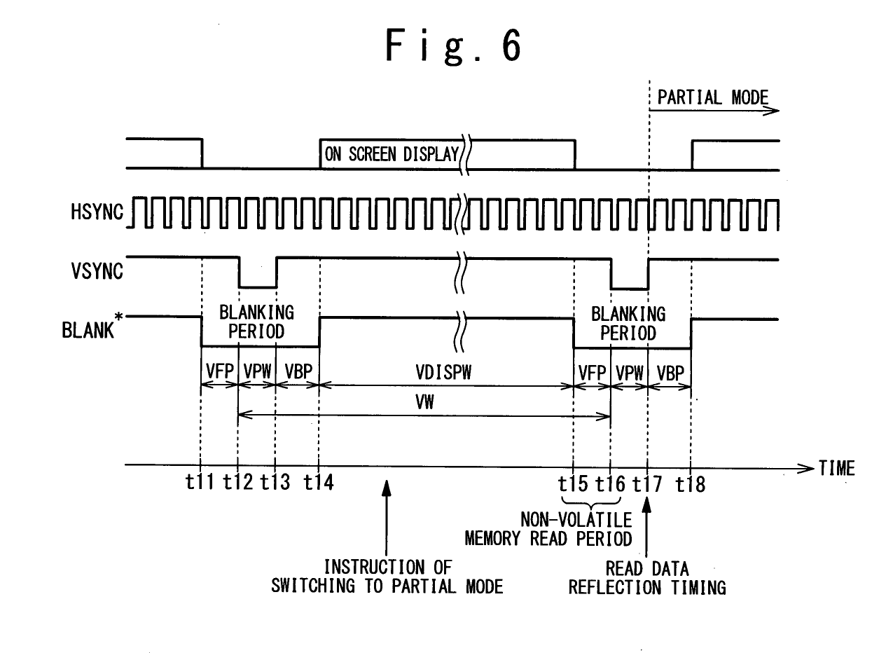

FIG. 6 is a timing chart showing an operation of the liquid crystal display device 1. Here, a “HSYNC” shows a horizontal synchronization signal. A “VSYNC” shows a vertical synchronization signal. A “BLANK” shows a blanking interval. A “VW” shows a vertical synchronization width. A “VPW” shows a vertical synchronization signal width. A “VDISPW” shows a vertical display period width. A “VFP” shows a vertical front porch. A “VBP” shows a vertical back porch. FIG. 6 shows a timing chart of an operation when an instruction for changing the display mode to the partial mode is outputted during image display in the normal display mode. In a case where, for example, the CPU 6 outputs the instruction for changing the display mode to the partial mode between the timing t14 and the timing t15, the value stored in the display mode setting register 14 is changed. At this time, in response to the changed value of the display mode setting register 14, a display mode signal outputted by the display mode setting register 14 is changed. The display mode signal is outputted from the display mode setting register 14 to the display mode change monitoring circuit 16.

The display mode change monitoring circuit 16 monitors whether or not the display mode is changed (switched). When the display mode change monitoring circuit 16 detects the change in the display mode, the display mode change monitoring circuit 16 outputs a read request signal REQ1, which indicates a request for reading the non-volatile memory 7, to the request arbiter circuit 18. The request arbiter circuit 18 supplies a read request signal REQ to the non-volatile memory control circuit 19. At this time, the request arbiter circuit 18 enables a request with a higher priority per frame based on a predetermined priority order in a case where a plurality of requests is supplied to the non-volatile memory control circuit 19 during the same frame period.

The non-volatile memory control circuit 19 detects the timing, at which a blanking interval starts, in response to a blanking start signal outputted from the timing controller 13. As illustrated in FIG. 6, the non-volatile memory control circuit 19 accesses the non-volatile memory 7 at the timing t15 (at the head of the front porch), based on the situation of the request.

Furthermore, the non-volatile memory control circuit 19 sequentially stores the data read from the non-volatile memory 7 in the setting register 12. FIG. 5 illustrates an example of the data stored in the non-volatile memory 7. In the case of the mode change from the normal mode to the partial mode, the non-volatile memory control circuit 19 reads the partial mode setting value of the partial mode setting value holding region 7-3.

The data read from the non-volatile memory 7 is once latched in the setting register 12. At the timing t17, the display control circuit 3 reflects the read data at the head of the frame (at the head of the back porch). In this manner, the setting value of the non-volatile memory 7 can be stored in the setting register 12 without any adverse influence on image display.

In the meantime, the same goes also for a change in the gamma correction value as the change in the display mode. In this case where, similarly, for example, the CPU 6 outputs the instruction for changing the first gamma setting value to the second gamma setting value between the timing t14 and the timing t15, the value stored in the gamma correction setting register 15 is changed. At this time, in response to the changed value of the gamma correction setting register 15, a gamma setting value signal outputted by the gamma correction setting register 15 is changed. The gamma correction value change monitoring circuit 17 recognizes the change in the gamma correction setting register 15 in response to the gamma setting value signal. Then, the gamma correction value change monitoring circuit 17 supplies a read request signal REQ2, which indicates a request for reading the non-volatile memory 7, to the request arbiter circuit 18. The request arbiter circuit 18 supplies a read request signal REQ to the non-volatile memory control circuit 19. The non-volatile memory control circuit 19 detects the timing, at which the blanking interval starts, in response to the blanking start signal outputted from the timing controller 13. Then, the non-volatile memory control circuit 19 reads a corresponding gamma setting value from the non-volatile memory 7 based on the read request signal REQ. Thereafter, the non-volatile memory control circuit 19 stores the read gamma setting value in the setting register 12. For example, in a case where the first gamma correction value is changed (switched) to the second gamma correction value, the non-volatile memory control circuit 19 reads the second gamma setting value storing region 7-7. In this manner, the setting value of the non-volatile memory 7 can be stored in the setting register 12 without any adverse influence on image display.

Besides, the same goes also for a change in gamma setting value in the gamma setting circuit 21 in response to a value from the external light sensor 22. In this case, instead of the gamma correction setting register 15, the gamma setting circuit 21 outputs the gamma setting signal to the gamma correction value change monitoring circuit 17.

In addition to a technique of saving power consumption in the above-described partial mode, the power consumption may be saved by, for example, displaying images with eight colors. In this case, an interval of a refresh for the display area may be increased by prolonging the blanking interval, thus saving the power consumption. In this case, the setting value such as the blanking interval is stored in the register. And then, if the setting value can be automatically changed in a case of the change in display mode, the power consumption can be finely saved per mode without setting by the host.

As described above, in the present embodiment, the mode setting value is stored in the non-volatile memory connected to the liquid crystal display device. The setting value of the non-volatile memory is read at the beginning of the blanking interval, and then, the read setting value is reflected at the head of the frame. Consequently, the setting value can be reflected without any adverse influence on image display. Additionally, a circuit for monitoring the mode change is provided in the liquid crystal display device, so that the setting register can be changed without any necessity of a control from a processor. Because of rewriting the register setting every mode change, it is enough to dispose the minimum registers in the liquid crystal display device. It leads to prevention of any increase in circuit area.

The present invention provides a display device capable of switching the modes without any adverse influence on image display even if an instruction of updating a setting value (setting data) in a setting register is outputted during image display.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

What is claimed is:

1. A display device comprising:
a display control circuit configured to drive a display panel; and
a memory configured to store setting data for said display panel,
wherein said display control circuit reads said setting data from said memory in response to a blanking start signal indicative of a start timing of a blanking interval.

2. The display device according to claim 1, wherein said display control circuit includes:
a memory control circuit configured to read said setting data from said memory,
a setting register configured to store said read setting data, and
a timing controller,
wherein said timing controller outputs said blanking start signal to said memory control circuit, and
wherein said memory control circuit reads said setting data from said memory in response to said blanking start signal and outputs said setting data to said setting register.

3. The display device according to claim 2, wherein said display control circuit further includes:
a display state register section configured to store a first value indicative of a display state of said display panel, and
a display state monitor section configured to monitor said display state of said display panel based on said first value stored in said display state register section,
wherein when said first value is updated, said display state monitor section requests reading of new setting data corresponding to new display state indicated by said updated first value, and
wherein said memory control circuit reads said new setting data in response to said request.

4. The display device according to claim 3, wherein said display control circuit further includes:
a request arbiter circuit configured to judge priority orders of a plurality of requests including said request and read said new setting data based on said priority orders when said display state monitor section outputs said plurality of requests.

5. The display device according to claim 1, wherein said memory is a non-volatile memory.

6. The display device according to claim 1, wherein said display panel is a liquid crystal display panel.

7. The display device according to claim 1, wherein said display control circuit reflects said read setting data during said blanking interval.

8. A display driver circuit comprising:
a control circuit configured to read setting data of a display panel from a memory in synchronization with a front porch which indicates a start timing of a blanking interval, and drive said display panel based on said setting data.

9. The display driver circuit according to claim 8, wherein said control circuit further comprising:
a memory control circuit configured to read said setting data from said memory,
a setting register configured to store said read setting data, and
a timing controller,
wherein said timing controller outputs a blanking start signal indicative of said start timing of said blanking interval to said memory control circuit, and
wherein said memory control circuit reads said setting data from said memory in response to said blanking start signal and outputs said setting data to said setting register.

10. The display driver circuit according to claim 9, wherein said control circuit further comprising:
a display state register section configured to store a first value indicative of a display state of said display panel; and
a display state monitor section configured to monitor said display state of said display panel based on said first value stored in said display state register section;
wherein when said first value is updated, said display state monitor section requests reading of new setting data corresponding to new display state indicated by said updated first value, and
wherein said memory control circuit reads said new setting data in response to said request.

11. The display driver circuit according to claim 10, wherein said control circuit further comprising:
a request arbiter circuit configured to judge priority orders of a plurality of requests including said request and read said new setting data based on said priority orders when said display state monitor section outputs said plurality of requests.

12. The display driver circuit according to claim 8, wherein said control circuit drives said display panel after said control circuit reflects said setting data into a setting resistor in synchronization with a back porch of said blanking interval.

13. An operation method of a display device, comprising:
outputting a blanking start signal indicative of a start timing of a blanking interval;
reading setting data for a display panel from a memory in synchronization with said blanking start signal; and
storing said setting data in a setting register.

14. The operation method of a display device according to claim 13, further comprising:
driving said display panel based on said setting data stored in said setting register,
wherein said outputting step includes:
supplying said blanking start signal to a memory control circuit which reads said setting data from said memory, and
wherein said reading step includes:
reading said setting data from said memory in synchronization with said blanking start signal by said memory control circuit, and
supplying said read setting data to said setting register by said memory control circuit.

15. The operation method of a display device according to claim 13, further comprising:
detecting a display state of said display panel; and
requesting reading of new setting data corresponding to new display state when said display state is changed,
wherein said outputting step is executed in response to said requesting step.
